(19) United States
(12) Patent Application Publication
(10) Pub. No.: US 2014/0262737 A1
(43) Pub. Date: Sep. 18, 2014

(54) WAVE PISTON DESALINATOR

(71) Applicant: Rodney M. Shields, Ukiah, CA (US)

(72) Inventor: Rodney M. Shields, Ukiah, CA (US)

(73) Assignee: Mind Flow LLC, San Francisco, CA (US)

(21) Appl. No.: 13/836,819

(22) Filed: Mar. 15, 2013

(51) Int. Cl. C02F 1/04

(52) U.S. Cl. CPC C02F 1/04
USPC 203/11; 202/185.1; 203/10

(57) ABSTRACT

An apparatus and method for desalination use kinetic energy in ocean waves as a power source. The apparatus comprises a wave tank and a condensation tank, the wave tank and condensation tank being connected by two pipes, each with a one-way valve, that produced a cycle of water saturated air from the wave tank to the condensation tank with a return of relatively desaturated air back to the wave tank following condensation of water. The wave tank captures the up and down motion of the waves and converts it to a pumping action. Air inside the wave tank is compressed when a wave comes in and has a negative pressure when the wave recedes. A saline water spray is introduced during wave troughs. Water evaporates into the negative pressure air hydrating the air. When the next wave comes in the water level rises inside the wave tank pressurizing the air.

### BACKGROUND OF THE INVENTION

Life on earth depends on water. Historically people have gotten fresh water from sources such as rivers, streams, lakes and underground wells. Many of these traditional sources are unable to sustain increased demands, variations in local climate and other environmental factors.

More than 2 billion people in the world live without access to adequate clean water, according to the World Health Organization. They are projecting more than 4 billion people without fresh water by 2025.

There is a continuing and growing need for fresh water throughout the world. Only 3% of the earth's water is potable, and up to 75% of this supply is restricted to glaciers and ice caps. The remaining 97% of the earth's water is either saltwater or brackish water. Although these bodies of water support vibrant ecosystems, they cannot be directly utilized for human use. In order to make these water sources viable for human consumption, a process known as desalination must be performed.

Desalination is a process that removes salt and other minerals in order to produce a source of fresh water. Current methods often involve reverse osmosis, distillation or evaporation. Current methods are usually highly complex with many different parts prone to failure in a harsh marine environment. The equipment required for these methods are expensive and challenging to manufacture, difficult to service, and are not economically feasible. Current methods require a high energy investment and are not environmentally friendly, due to reliance on fossil fuels and/or nuclear energy.

By using the natural kinetic energy of ocean waves, the cost of desalination can be greatly reduced. This also reduces negative environmental impact from nuclear or fossil fuel power. Instead of using pumps and motors, the ocean waves are able to naturally create the operational pressures necessary for desalination. These pressure changes allow water vapor to be isolated, and stored in a reservoir for future use.

The simple construction of this invention provides many advantages over current designs. Complex designs create more opportunities for machine failures. This results in increased service calls, which are costly, and difficult to implement in a marine environment. The simple design would also greatly reduce manufacturing costs. This design could also be used for aquaculture, or as a breakwater. Individual desalinators can also be combined to form an array or network, which would reduce maintenance costs, and increase production rates.

### BRIEF SUMMARY OF THE INVENTION

The current invention harnesses the kinetic energy of naturally occurring waves to power desalination of saltwater. In an alternate embodiment, the device is composed of at least two tanks. A wave tank allows intake of ocean water, and a condensation tank collects fresh water condensation. The wave tank captures the up and down motion of the waves and converts it to a pumping action. This pumping action powers the system. Air above the waterline inside the wave tank is compressed as the wave induced water level rises and has a negative pressure when the wave recedes. When the water level recedes and the air is under negative pressure or a partial vacuum, saline water spray is introduced. Water evaporates into the negative pressure air hydrating the air. When the next wave comes in the water level rises inside the wave tank pressurizing the air.

A one-way valve connects the two tanks through a pipe at the top of the device. This one-way valve allows the pressurized and hydrated air from the wave tank to pass through to the condensation tank and prevents the moist air from the condensation tank from returning to the water tank. The pipe also prevents salt water from large waves spilling into the condensation tank and contaminating the fresh water. Because the boiling point of water decreases as air pressure is elevated, the air pressure is maintained above atmospheric pressure inside the condensation tank to assist in the condensation process.

The two tanks are also connected by a second air passage. This air passage or pipe contains a separate one-way valve which allows pressurized air from the condensation tank to return to the wave tank. In some embodiments, after passing through the one-way valve, the pressurized air passes through an aerator, creating bubbles in the salt water. This bubbling action helps create moist air in the wave tank.

At the bottom of the condensation tank the condensed fresh water collects and a supply line delivers freshwater to where desired. This supply line also has a pressurized one-way valve. The condensation tank is most effective at a high pressure, so release of the freshwater must be regulated in order to prevent an unwanted drop in pressure.

The device could be anchored in place if necessary, but it is also possible for it to change locations. In some embodiments of the invention, the apparatus may include resistance plates that act as support for the wave and condensation tanks. In buoyed embodiments of the invention, these resistance plates may be attached to buoyancy devices, integrated with floating platforms, or constructed of buoyant material in order to support the device on or near the surface of the water. In some embodiments, the resistance plate at the bottom of the device can be segmented into multiple resistance plates. By locking and unlocking different segments as waves go through the device, it is possible for the device to navigate to different locations. These segments act as fins to convert the wave's up and down motion into lateral motion. This navigation would allow the device to be easily repositioned for optimal environmental conditions.

The device will utilize a variety of materials in order to satisfy the constraints of both the device and the marine environment: wood, concrete, plastics, various metals, ceramic, terracotta, ferrocement, composite materials, fiberglass, etc. The device would ideally be resistant to weather conditions, non-corrosive, tolerant to ultraviolet rays, and be able to withstand rough waves and wind. Additionally, it may be desirable to be constructed of a resilient material that would bounce off of mis-navigated vessels to prevent damage to either the vessel or the desalinator. A person of skill in the art will understand that the apparatus could be constructed of a variety of materials, depending on the needs and specifications of an individual user.

There are a number of configurations that are possible for this invention. The general concept is the same between variations, with one or more wave tanks to capture the energy of the waves, and one or more tanks to condense water vapor out of hydrated air at least two one-way valves connecting the tanks, one in each direction, and resistance plates being used in most designs. Each variation achieves the same goal of collecting fresh water. The tanks can be stationary, mobile, floating, or land bound. They can be isolated, grouped, or form a large network or array. There are also many ways of created hydrated air that will be further described. The same underlying principles are present in each design, but the flexibility of this invention is another reason why it is superior to current technology.

### BRIEF DESCRIPTION OF DRAWINGS

FIG. 1. Example of the physical structure of the basic device.

FIG. 2. Alternative design of the basic device.

FIG. 3. Example of the physical structure of the device with the air water spray.

FIG. 4. Detailed illustration of carburetor component.

FIG. 5. This shows the individual desalinator with air and water mixer.

FIG. 6. Individual desalinator with aerator.

FIG. 7. Shore based design with air-water mix carburetor.

FIG. 8. Shore based design with aerator.

FIG. 9. Shore based design with generator.

FIG. 10. Desalinator with salt water pump

FIG. 11. Detailed illustration of salt water pump

FIG. 12. Network on desalinators with central fresh water outlet.

FIG. 13. Network of desalinators with segmented resistance plates.

FIG. 14. Alternative view of desalinator with segmented resistance plates.

FIG. 15. Top view of desalinator network with segmented resistance plates.

FIG. 16. Individual desalinator network with segmented resistance plates.

FIG. 17. Interconnected desalinator network with segmented resistance plates and protective shell.

FIG. 18. Network of desalinators with segmented resistance plates and resistance fins.

FIG. 19. Desalinator with large condensation tank and dual generators.

FIG. 20. Alternate embodiment of desalinator in which the tank shaped to help focus the waves' energy and compress air into a smaller area.

### DETAILED DESCRIPTION OF THE INVENTION

Basic Design:

The desalinator can be arranged in an infinite number of configurations. Each design comprises at least the following key components: a salt water intake tank with an intake capable of receiving saltwater that is subject to wave action, a condensation tank, and two separate one-way valves that connect the two tanks. These one-way valves allow for the movement of pressurized and saturated air between tanks. The intake tank is situated so the saltwater partially fills the intake tank, but with a layer of water-saturated air situated above the saltwater. The waterline of the saltwater in the intake valve is allowed to rise and fall with wave action that is communicated through the saltwater intake. A first conduit connects the intake tank and the condensation tank. An air intake, which opens the first conduit, is situated high enough within the intake tank that it is essentially always above the waterline in the intake tank, with a vent into the condensation tank connected to the outbound end of the first conduit, and the first one-way valve located between the air intake and vent. These one way valves allow for the exchange of pressurized and saturated air between tanks and helps maintain a positive air pressure within the condensation tank. Fresh water is collected in the condensation tank, and removed for transit or storage in a reservoir. A second conduit returns from the condensation tank back to the intake tank, with a second one-way valve situated so that air travels from the condensation tank to the intake tank. The second conduit may be constructed so that returning air is vented under the water level of the intake tank. One embodiment of the invention is shown in FIG. 1.

The desalination process varies whether a wave is incoming or receding. When a wave is incoming, the water level rises inside the wave tank (101), which causes an increase in pressure in the layer of water-saturated air above the saltwater. When a wave recedes, the water level drops causing a partial vacuum or negative pressure to form in the air above the water inside of the wave tank. Capturing the waves' energy and converting it into a cycle of positive and negative pressure powers the desalination system. When air is under a partial vacuum water sprayed into the air is more prone to evaporate. One way valves allow for the exchange of pressurized and saturated air between tanks. In some embodiments, the valves are adjusted to maintain a positive air pressure within the condensation tank. When air is under pressure, the air is more prone to release the water it holds through condensation.

In floating embodiments of the invention, the system usesair retained in both the wave tank and a condensation tank to help maintain buoyancy through. The materials used in the construction of said tanks could also be buoyant to aid in the buoyancy of the entire system. The height of the system is such that the top remains above most waves in the area where the device is deployed, while the bottom is below the trough or the low water mark between the waves. This buoyancy level and the height in which the system maintains in the water can be manufactured into the system through the choice of buoyant materials in the construction of the system in smaller less complex configurations or the buoyancy can be controlled and adjusted by monitoring and metering the amount of air in the system through a system of monitors and controls in a more complex system described below.

When a wave is incoming and the water level rises inside the wave tank, this pressurizes water saturated air in the wave tank above the water which forces the water-saturated air to travel under pressure, through a one-way valve (104) into the condensation tank. The pressure inside the condensation tank is higher than local atmospheric pressure yet lower than the pressure in the wave tank when the wave is reaching its peak. The air pressure fluctuates in the condensation tank as air is pumped in and then released, yet since water vapor in air under pressure is more prone to condensation, the air pressure may be kept at a pressure higher than the local atmospheric pressure to facilitate the condensation process. A float valve (103) allows saturated air through the one-way valve, but prevents unwanted salt water from entering the condensation tank and contaminating the condensation tank (102). Once inside the condensation tank, the water vapor in the air condenses on the sides of the condensation tank, and collects at the bottom of the tank. The fresh water that collects at the bottom of the condensation tank may be forced out periodically by the air pressure in the condensation tank, or may drain through the use of gravity or pumps.

In some embodiments, optional cooling fins could extend inside as well as outside of the condensation tank to more effectively transfer heat from the condensation of the water vapor to the cooler ocean waters. In some embodiments, it might be desirable to have the condensation tank in lower and cooler waters to aid in the condensation process, or to pump up cooler water from the deeper water. This cooler water could flow through heat exchangers in the condensation tank to provide a large surface area that is kept cold for the condensation process. These heat exchange fins could be incorporated into any or all of the configurations of the condensation tanks so that the heat exchange fins cool from contact with the larger body of water and provide a larger surface area for condensation surfaces. Similarly, a person of skill in the art will recognize that both the shape of the condensation tank and the placement of air intakes and outlets can be adjusted to increase the ability of the condensing unit to condense water, e.g., by creating a narrow, elongated condensation chamber similar to those used in conventional still. In areas where the surface water is warm, cooler water from a greater depth could be used to cool down the condensation tank increasing the efficiency of the system. Additionally, solar heat could be used to heat or pre-warm the salt water intake. This warmer salt water is more prone to evaporation. Attached or detached floating solar collectors could be used in many of the configurations described here in to heat up the intake of salt water.

When the wave recedes, the water level falls in the wave tank. This causes the air pressure to drop inside the wave tank. At this point, some of the air from the pressurized condensation tank is released through a separate one-way valve (105). The air bubbles rise up into the water in the wave tank through an aerator (106). This bubbling action in the saltwater of the wave tank creates moisture rich air above the water line within the tank, which can then be feed back to the condensation tank when the next incoming wave arrives. Meanwhile, water vapor is condensing within the condensation tank. This condensation collects at the bottom of the condensation tank.

The fresh water condensation exits the desalinator through a one-way valve (107), and travels through the fresh water outlet (108) to a reservoir, collection system or pumped to shore as desired. This reservoir can be located immediately next to the desalinator, in a central location among other desalinators, or even on land. The release of fresh water is regulated by a pressurized one-way valve at the bottom of the tank. This valve helps maintains the pressure within the condensation tank, the increased pressure aiding the condensation process. The entire desalinator is connected to a resistance plate (109), which forms the foundation of the device. The resistance plate is a planar surface that is generally perpendicular to the up and down motion of the wave and provides resistance to the up and down movement. The resistance plate is heavier than the surrounding water and provides ballast and stability to the overall system. The resistance plate helps the desalinator maintain stability, and creates a platform for supporting the tanks. The resistance plate may weighted to counteract the buoyancy of the wave tank, providing ballast and stability to the entire system.

An alternate embodiment of the invention is shown in FIG. 2. The one-way valves that connect the wave tank (201) and the condensation tank (202) have different configurations than in FIG. 1, but retain the same functions. The main differences of this design are the addition of an air inlet at the top of the wave tank (203) and placement of the return one-way valve and air return. The return one-way valve (204) should be a valve that permits air but not water. The air inlet (203) at the top allows for easy adjustment of air levels within the tank. This could be done to maintain buoyancy or compensate for variances such as wave height. This air inlet could be an added feature to any of the other configurations. The air inlet could be remotely monitored and controlled with the addition of a control unit described in greater detail below. The second one-way valve (205) is attached to an aerator (206). This aerator has the same function as the aerator in FIG. 1 (106), but it has a different orientation. Once fresh water is collected, it is released through a pressurized one-way valve (207) at the bottom of the condensation tank (202). The one-way valve is connected to the fresh water outlet (208), which allows water to travel to a separate storage location. In some embodiments, the entire device is anchored to the sea floor and buoyed in the salt water. The resistance plate (209) provides ballast to the system, resists the up and down motion of the waves, serves as a base for both tanks, and helps maintain the entire system in an upright position.

### Water Spray Mix Design

A person of skill in the art will recognize that the descriptions above are not limiting, and that the invention provides opportunity for many variations. FIG. 3 illustrates an alternative embodiment of the saltwater intake mechanism. The wave tanks in FIGS. 1 and 2 (101, 201) had completely open bottoms, allowing free intake of incoming waves. The design in FIG. 3 uses a saltwater filter (305) to filter the intake of salt water at the bottom of the wave tank. This water travels up the saltwater supply pipe (304), and is sprayed into the evaporation tank (301). Air from the pressurized condensation (302) tank mixes with the salt water spray (303) to create moist, hydrated air and salt water droplets that fall to the bottom of the wave tank. The water level within the salt water supply pipe (304) is maintained at a constant level. A valve prevents the salt water from flowing back down the supply pipe. The water is sprayed into the evaporation tank, but the valve does not allow the salt water to drain completely back down the salt water supply tube. By maintaining a constant water supply, energy is not wasted refilling the salt water supply line with each wave. A salt water drain (306) allows excess salt water to drain back into the ocean. An air compensating valve (307) allows extra air to be introduced into the wave tank (301) to maintain buoyancy or to adjust the system to changing wave heights. The hydrated air from the wave tank (301) travels under pressure to the condensation tank (302) through a one-way valve for hydrated air (308). Once in the condensation tank, water in the hydrated air condenses, which creates a collection of fresh water at the bottom of the condensation tank (302). As water exits the salt water drain (306), pressure in the wave tank decreases, pulling excess air from the condensation tank back into the wave tank (301) through the one-way valve for hydrated air (308). As mentioned earlier, this air helps aerate the incoming salt water before it is sprayed into the wave tank (301). The collected fresh water is released from the condensation tank (302) through a fresh water outlet valve (310), which is connected to a fresh water outlet pipe (312). The resistance plate (311) resists the up and down motion of the waves, provides ballast to the system and creates a foundation for both tanks

Another embodiment of the invention includes the addition of a salt water spray (303) which allows for a better mixture between air and water. This air-water mixture is created using an air-water mixer similar to a carburetor, and is shown in detail in FIG. 4. Salt water enters through the salt water supply (401), and is allowed to enter the wave tank through the water outlet (405). This happens when the wave is receding and the air pressure is negative or at a partial vacuum. The nozzle orifice (402) and one-way flap valve (403) facilitate the incorporation of air into the water supply before it is released to the wave tank (406). The air flow (404) into the carburetor comes from the condensation tank (not shown). FIGS. 4A and 4C show water being released, because the one-way flap valve (403) is open. Conversely, FIGS. 4B and 4D show the assembly when the one-way flap valve is closed (403). The air-water mixture can be further enhanced with the addition of an optional aerator (408), as shown in FIGS. 4C-D. This aerator breaks up the water using air from the air tube inlet (407). This allows air from the condensation tank to be further incorporated into the hydrated air being released into the wave tank (406).

### Wave Piston Air Pump Design

As mentioned earlier, it is not necessary for the condensation tank to be in close proximity to the evaporation wave tank, as was shown in FIGS. 1 through 3. FIGS. 5A-B show an alternative embodiment of a wave tank for a system in which multiple wave tanks (501) are connected to one or more condensation tank(s). As shown in FIG. 5A, in this embodiment, air enters a wave tank through a snorkel-like air inlet (502). Salt water is drawn in through a filter at the bottom of the tank (505), and passes through a mixing unit (503) capable of aerosolizing the air/water mixture into the air (506). The hydrated air is then transferred through a one-way valve (507) to a separate condensation tank through the hydrated air outlet (508). A resistance plate (509) provides resistance to the up and down movement of the waves and provides a foundation for the wave tank (501).

FIG. 5B shows a cutaway view of the air and water mixer mechanism. This design provides an alternative method of aerating the water. The air inlet (502) allows air to be incorporated from the top of the wave tank. The air inlet is a long tube that extends into the salt water inlet (504) in order to facilitate the creation of an air and water mixture. The mechanism of action behind this device is similar to blowing through a straw into water. When a wave recedes and the air pressure drops inside the wave tank, air from the air inlet blows in and bubbles up through the saline water inlet, creating an air and water mixture. This air-water mixture is then sprayed out into the wave tank (501) through the air and water mixer (503).

An alternative version of this design can be seen in FIG. 6. Instead of spraying aerated water into the tank, an aerator (603) is use to create an air-water mixture at the bottom of the wave tank (601). This aerator creates bubbles in the salt water as it comes into the tank. Air is incorporated into the aerator through an air filter (607) at the top of the wave tank (601). This filter ensures that debris does not enter and clog the air inlet (602). Similar to the design in FIG. 5, the hydrated air leaves the wave tank through a one-way valve (604), and travels through the hydrated air outlet (605) to one or more central condensation tank(s) (not shown). A resistance plate (606) provides resistance to the up and down motion of the waves and provides a foundation for the wave tank (601).

### Shoreline Design

In another embodiment of the invention, the desalinator is anchored to land instead of buoyed in water. A person of skill in the art will understand that any of the embodiments described above in relation to FIGS. 1-6 could be adapted to an anchored embodiment of the invention. This design uses the same principles as FIGS. 1 through 6, but has a large funnel that allows for water intake. This design can be seen in FIG. 7.

In this embodiment, a large funnel design (704) would be used to facilitate the intake of salt water (707), which concentrates and amplifies the energy of the wave into the wave pump tank (701). An air supply is located at the top of the wave pump tank (705). An optional exterior shell (706) covers the entire desalination device. This shell can be both protective and decorative. A stone like finish could help the desalinator blend into its surroundings, as well as protect it from the harsh marine environment. Similar to the other designs (FIGS. 1-3, 5-6), fresh water is drawn off of the condensation tank (702), and stored in a fresh water tank (703). This fresh water supply can be located centrally within a network of desalination devices, or proximal to each individual desalinator.

An alternative embodiment of the shore-based design is shown in FIG. 8. This design is very similar to FIG. 2, in that it utilizes an aerator attached to the second one-way valve. Unlike FIG. 7, this design features an open bottom on the wave pump tank (801). Instead of funneling salt water into a pipe before aeration, the entire salt water supply (807) is in contact with the aerator after passing through the salt water inlet (804). Because of the unregulated salt water intake, a float in the upper one-way valve prevents salt water from traveling to the condensation tank (802). This one-way valve only allows hydrated air to pass through to the condensation tank. Once freshwater is collected in the condensation tank, a similar float is used to regulate the release of water into the fresh water tank (803). An optional exterior shell (806) protects the device from the environment, and an air supply (805) is located at the top of the wave tank.

A third embodiment of the shore-based design can be seen in FIG. 9. Similar to FIGS. 7-8, the desalinator utilizes a wave tank (901) to collect ocean water waves (907). The bottom of the wave tank is open, which allows it to function as the salt water inlet (904). This means water is able to freely flow in with each incoming wave. Air is introduced into the salt water with an aerator (912) using air from the air supply (905) located about the wave pump tank. Pressure builds as waves come into the wave tank, which forces water-saturated air through a one-way valve (909). A float valve (908) prevents ocean water from accidentally getting into the one-way valve. After going through the one-way valve, the saturated air is collected in the condensation and compressed air storage (902). The water vapor in the saturated air condenses, and collects at the bottom of the tank. This fresh water is released through the fresh water outlet (903). An optional exterior shell (906) provides protection, and helps the desalinator blend in with the environment.

A unique feature of this design is the optional generator (910) located on the top of the condensation tank. While the generator is a completely optional component, it utilizes the compressed air that is already collected as part of the desalination process. Compressed air feeds into a turbine that powers the generator, and is then released through the air outlet (911). This would provide additional energy, without any harm to the environment.

### Salt Water Pump

Another preferred embodiment of the invention is shown in FIG. 10. This embodiment utilizes a salt water pump (1006) to spray salt water into the wave tank (1001) with each receding wave. The salt water pump is anchored to the wave tank at the base, and the top of the pump moves with each wave to spray salt water into the layer of air in the upper portion of the wave tank. When the next wave come in the water level rises and compresses the water-saturated air above the waterline inside the wave tank. This pressurized water-saturated air flows through the one-way valve (1004) and into the condensation tank (1002), which builds pressure in the condensation tank. A float valve (1003) prevents ocean water from accidentally getting into the condensation tank. The water vapor in the hydrated air within the condensation tank condenses and forms fresh water. This fresh water is released through the fresh water outlet (1008). As the wave recedes, the air pressure drops inside the wave tank, and air from the condensation tank is returned through the second one-way valve (1007) and then an aerator located in the wave tank and the salt water pump sprays additional water into the partial vacuum air The bubbling generated by the aerator helps create moisture rich air in the upper part of the wave tank, in order to start the cycle again. In preferred embodiments of the invention, both tanks use a resistance plate (1009) to resist the up and down movement of the waves, and to maintain buoyancy and stability.

A detailed illustration of the salt water pump can be seen in FIG. 11. Salt water comes into the pump through a water filter (101) located at the base of the pump. The salt water travels up through the water supply tube (1102) and through a one-way valve (1103). The pump cylinder (1104) moves up and down with the motion of the waves (1106), as illustrated in parts A and B of FIG. 11. When the wave is incoming, the pump cylinder moves up as well drawing water into the pump cylinder. When the wave is receding, the pump cylinder moves down, and the salt water that came from the one-way valve (1103) is forced out through the spray valve (1105). Ultimately, this design is simply another way of introducing hydrated air into the wave tank.

### Segmented Resistance Plates

In some embodiments of the invention, individual desalinators can interconnect to form a network or and array. This network could support aquaculture, or could even be used as a breakwater to reduce the amount of damage caused by storm amplified waves by capturing some of that wave energy. An example of a desalinator network can be seen in FIG. 12. Each desalinator consists of an evaporation tank (1201) and a condensation tank (1202), which is connected to a central fresh water outlet (1206). A unique feature of this design is segmented resistance plates (1203), which anchor the tanks Hinges (1204) allow the network to be flexible within the motion of ocean waves. A person of skill in the art will recognize that a variety of different types of hinges may be used to allow increased flexibility of movement by the plates along different axes in three dimensions. An optional controller (1205) at the top of the network can be used to monitor water level in each of the tanks, as well as the geographical position of the network, wave height, water temperature, desalination efficiency and filter status among other sensors and control to valves. This information and control could be transmitted to operators anywhere through any of the different means of data transmission available, in order to provide information about performance and required maintenance. The controller could use sensors to monitor conditions both inside and outside each of the tanks and to adjust and control the systems and valves, actuate and control the flow through the system in order to maximize the efficiency of water and energy production. Although not depicted in every drawing, this technology could be included in any of the designs. Although FIG. 12 shows a network of the units described in FIG. 2, a person of skill in the art will recognize that any of the individual wave-powered purification units described above could be formed into networks in this manner.

A more detailed view of the segmented resistance plates (1301) and hinges (1302) can be seen in FIG. 13. This view is oriented from the bottom of the device (as if looking up from underneath). The circles represent the wave pump tanks (1303) and condensation tanks (1304). A central control unit (1305) may be located on top of the desalinators. The holes in the resistance plates (1306) allow the passage of water and sea life through the network of desalinators.

An alternative configuration of this design can be seen in FIG. 14. This figure shows a side view of the desalinator with hinged resistance plates. It also shows a bottom view of resistance plates on an individual desalinator. The evaporation wave tank (1401) and condensation tank (1402) are connected to resistance plates (1403). The fresh water outlet (1406) allows the collected water to be transported to a separate location for storage. A unique feature of this design is that the hinged resistance plates are able to facilitate movement of the entire assembly. As seen in FIG. 14A, the hinges (1404) allow the segmented resistance plates (1403) to create a flipper-like motion by folding and unfolding each resistance plate. As seen in FIG. 14B, these resistance plates circle the desalinator. As the resistance plates undulate, they are able to move the entire desalinator with a jellyfish like motion. A controller (1405) at the top of the network operates the hinges within each resistance plate. This control unit could use GPS or other positioning technologies to either maintain, or change the location of the entire desalination network. The control unit could also be used to monitor water levels and other maintenance concerns. However, this control unit has the ability to change the position of the desalinator without external locomotion. Instead of requiring manual towing, the geographical position could be adjusted using the segmented resistance plates. This mobility helps minimize environmental impact and achieve optimal conditions for desalination.

This configuration can be seen from a second view in FIG. 15. The figure shows the same desalinator configuration, but from a higher perspective. In this figure the one-way valves (1507, 1508) can be clearly identified between the wave tank (1501) and the condensation tank (1502), as well as an exemplary placement of the controller (1505). The segmented resistance plates (1503) and locking/unlocking hinges (1504) function as described in FIG. 14. The fresh water outlet (1506) can be connected to a central line, or could service an individual collecting tank.

FIG. 16 shows how the desalinators with segmented resistance plates (1603) can move convert some of the waves' up and down motion into lateral movement. Here the waves are moving from left to right. As the wave recedes for the assembly on the left the resistance fins are locked by locking the locking/unlocking hinges (1604) into place and as the assembly sinks behind the receding wave the angle of the fins imparts a lateral movement of the assembly to the right. The assembly in the middle is at rest at the trough of the wave. The assembly on the right wants to rise with the incoming wave and the locking and unlocking fins are in position to convert the upward motion of the assembly into a lateral movement to the right. Each desalinator has an individual evaporation wave tank (1601), condensation tank (1602), controller (1605), and fresh water outlet (1606).

FIG. 17 shows an alternative desalinator array or network where the tanks are physically connected by both resistance plates (1703) with hinges (1704) and a central fresh water outlet (1706). An addition to this figure is the protective and decorative shell (1707). This is an optional component that could help the device blend into the environment, as well as offer additional strength and protection. A controller (1705) can be used to monitor water level in each of the tanks, as well as the geographical position of the network, wave height, water temperature, desalination efficiency and filter status among other sensors and control to valves. This information and control could be transmitted to operators anywhere through any of the different means of data transmission available, in order to provide information about performance and required maintenance. The controller could use sensors to monitor conditions both inside and outside each of the tanks and to adjust and control the systems and valves, actuate and control the flow through the system in order to maximize the efficiency of water and energy production. The controller could also be used to direct the lateral motion of the array and to reposition the array as needed. Although not depicted in every drawing, this technology could be included in any of the designs.

Another configuration of the desalination network can be seen in FIG. 18. This configuration also utilizes segmented resistance plates (1801) surrounding each wave pump tank (1803), along with a central control unit (1804) with the same functions as described with the controller of FIG. 17. In this alternate embodiment, the resistance plates along the out perimeter of the network act as resistance fins (1802). This configuration allows the desalinator to be clustered in a network or array such as FIG. 13, but also have the ability to move. The resistance fins act as flippers to move the entire desalinator network within the ocean waves as previously shown with the resistance fins in FIGS. 14 through 16. This configuration is one embodiment and is not intended to be limiting. A person of skill in the art will recognize that traditional means of locomotion, such as motors attached to the network, or attachment to a tow vessel could also be used to move the network of desalinators.

### Dual Generator Desalinator

As discussed earlier in relation to FIG. 9, the invention can include incorporation of electrical generators into the desalinator. FIG. 19 shows a design that utilizes two generators at both the top and bottom of the condensation tank. Similar to other designs, a wave tank is used to introduce salt water into the system. As waves (1902) force water into the wave pump tank (1901), hydrated air (1903) is transferred to the condensation tank through a flexible supply line. Because the desalinator is floating in the ocean, salt water can also be introduced into the system at the bottom of the condensation tank through a water filter (910). A flexible non-permeable membrane (1904) separates the ocean water from hydrated air within the condensation tank and prevents the compressed air from dissolving into the salt water. Fresh water condensation is collected above the membrane, and released through the fresh water outlet (1911) for storage. The condensation tank has an outer reservoir shell (1907) that provides protection, stability, and buoyancy. It should be noted that the reservoir tank (1907) is much thicker at the bottom, which provides ballast and helps the system maintain stability.

The dual generators and the membrane create a complex system interaction within the condensation tank that allows for fresh water condensation and energy generation. As hydrated air builds pressure above the membrane, water can be released through the generator at the bottom of the tank generating electricity. As the volume of air above the membrane is allowed to expand, the buoyancy of the tank increases. As the air pressure continues to build and the volume of air expands inside the tank the air pressure can be released through the generator at the top of the tank (1905) and out through the air outlet (1906) generating electricity in the process. As pressure is released, water can be reintroduced through the water filter (1910) and through the generator (1909), generating electricity in the process. This sea water fills in the condensation tank below the membrane through water filter (1910), and the volume of air decreases. This causes the tank to lose buoyancy, as well as generate energy. In order to maintain the proper buoyancy, water can be introduced through the water filter at the bottom of the tank (1910). Introducing water through the water filter (1910) would cause the condensation tank to lose buoyancy. When pressurized salt water is released back out of the tank through the water valve (1908) it regains buoyancy, as well as generating energy through the bottom turbine and generator (1909). In order to generate the maximum amount of electricity, pressure can be relieved through both generators at the same time if necessary. The generators of this design are an optional feature, but they utilize conditions that are already present in order to generate an additional source of energy. This energy could be used for any number of purposes and could be cabled to shore if desired. Pressurized air could be stored inside the condensation tank and used for generating electricity when needed. This allow the unit to store energy and produce electricity on demand.

FIG. 20 illustrates another embodiment of the invention in which the shape of the tank is modified. Here the wave tank (2001) is shaped to help focus the waves' energy and compressing air into a smaller area, thus increasing the pressure of the air at the top of the tank when a wave is incoming. This pushes air through a float valve (2003) and a one way valve (2004) into a condensation tank that could be adjacent or at a distance. (2002) shows an adjacent condensation tank where water from saturated air condenses and collects at the bottom of the tank. Air could return to the wave tank through the one way valve (2005) and an aerator (2006) when the wave is receding and the water level and the air pressure drops inside the tank. Fresh water is released under pressure from the pressurized condensation tank through a one way valve (2007) and through a fresh water outlet (2008). The resistance plate (2009) provides resistance to the up and down movement of the waves and could be segmented as described previously. Although only one configuration of the invention is shown with the bell shaped wave tank, other configurations could also have a bell shape that focuses the waves' energy and concentrates the air into a smaller area.

1. An apparatus for desalination of water, comprising:
a wave tank;
a condensation tank;
a first one-way valve, coupled to an intake in the wave tank and connecting said wave tank and said evaporation tank, wherein the first one-way valve is oriented to allow air to move from the wave tank to the condensation tank, and wherein said intake is not immersed in liquid water at the bottom of the wave tank;
a second one-way valve, connecting said condensation tank to said wave tank, oriented to return air to the wave-tank from the condensation tank.

2. The apparatus of claim 1, further comprising an outlet coupled to the second one-way valve and an aerator coupled to said outlet, wherein said aerator is situated so that it is below still water level in the wave tank.

3. The apparatus of claim 1, further comprising a float valve attached to and covering said intake in the wave tank coupled to the first one-way valve

4. The apparatus of claim 1, further comprising a fresh water outlet with a one-way valve situated to allow fresh water to exit the condensation tank, said fresh water outlet one-way valve being adjustable to prevent outflow through the fresh water outlet unless a selected minimum pressure is exerted on said fresh water outlet one-way valve.

5. The apparatus of claim 1, wherein the apparatus is attached to land by a rigid foundation.

6. The apparatus of claim 5, wherein the apparatus is covered with an external shell.

7. The apparatus of claim 1, further comprising at least one resistance plate.

8. The apparatus of claim 7, further comprising at least two resistance plates, wherein the at least two resistance plates are arranged around the circumference of the apparatus.

9. The apparatus of claim 8, further comprising:
at least one locomotion unit attached to each of the at least two resistance plates, capable of controlling the movement of the resistance plates; and
a control unit, capable of controlling the locomotion unit.

10. The apparatus of claim 9, wherein each of the least two resistance plates is connected to the outer portion of the apparatus by a hinge.

11. The apparatus of claim 9, wherein the least two resistance plates are constructed of a flexible polymer.

12. The apparatus of claim 1, further comprising heat conductive fins that extend into the condensation tank.

13. The apparatus of claim 1, further comprising a heat exchanger in the condensation tank.

14. The apparatus of claim 1, further comprising
a return outlet attached to the second one-way valve and directed into the wave tank, with a return nozzle attached to the distal end of the return outlet from the second one-way valve;
a salt water supply situated to allow salt water into to the wave tank, said salt water supply having an outlet within the wave tank and a salt water filter situated so that it is capable of filtering incoming salt water; and
an outlet for the salt water supply, positioned adjacent to the return nozzle, wherein the opening of said outlet for the salt water supply is positioned to deliver salt water into the flow path of the return nozzle orifice so that the return nozzle is capable of creating an air and salt water spray.

15. The apparatus of claim 14, further comprising a return line connecting the second one-way valve and return nozzle, said return line having an air tube attached to and extending the return line, said air tube situated to return air into the salt water supply prior to the salt water supply outlet to the return nozzle, and wherein the air tube has an aerator at its distal end.

16. The apparatus of claim 1, further comprising
a salt water inlet extending upward from the bottom portion of the wave tank, said salt water inlet having an air-water mixer at its upper outlet into the wave tank;
an air inlet extending from the top portion of the wave tank into the salt water supply, said air inlet being capable of introducing air within the salt water inlet.

17. The apparatus of claim 1, further comprising:
a flexible water-tight membrane attached to the inner surface of the condensation tank and extending across the condensation tank to form a water-tight seal;
a salt water inlet into the condensation tank;
said membrane being attached to the inner surface of the condensation tank below the vent of the first one-way valve into the condensation tank and above the salt water inlet to divide the inner volume of the condensation tank into an air bladder and a water bladder;
an air-powered generator attached to the upper portion of the condensation tank, said generator having an air inlet within the air bladder of the condensation tank and a vent to the exterior of the condensation tank.

18. The apparatus of claim 17, further comprising:
a water-powered generator attached to the condensation tank, said water-powered generator having a water inlet within the water bladder of the condensation tank and a vent that is external to the condensation tank.

19. The apparatus of claim 1, further comprising:
a salt water supply tube with a salt water pump attached to its upper end.

20. An apparatus for desalination of water, comprising:
at least one condensation tank, each condensation tank having a drain connected to a fresh water outlet;
at least one wave tank at least one saturated air conduit, each saturated air conduit being attached to one of the at least one wave tanks and one of the at least one condensation tanks, and wherein each saturated air conduit includes a one-way valve oriented so that air may flow to the attached one of the at least one condensation tanks; and
at least one return conduit, each return conduit being attached to one of the at least one condensation tanks and one of the at least one wave tanks, wherein each return conduit includes a one-way valve oriented so that air may flow out of the attached one of the at least one condensation tanks.

21. The apparatus of claim 20, wherein the number of return conduits is equal to the number of wave tanks.

22. The apparatus of claim 20, wherein the ratio of wave tanks to condensation tanks is greater than 1:1.

23. The apparatus of claim 20, further comprising
a salt water inlet extending upward from the bottom portion of each of the at least one wave tanks, said salt water inlet having an air-water mixer at its upper outlet into the wave tank;
an air inlet extending from the top portion of each of the at least one wave tanks into the salt water supply, said air inlet being capable of introducing air within the salt water inlet.

24. The apparatus of claim 20, further comprising:
at least one return nozzle, each return nozzle attached to the vent end of each said return conduit and located within one of the at least one wave tanks;
at least one wave tank salt water supply, each wave tank salt water supply having an outlet, said outlet positioned adjacent to one of said at least one return nozzles, wherein the opening of said outlet for the salt water supply is positioned to deliver salt water into the flow path of the return nozzle orifice.

25. The apparatus of claim 20, further comprising an interconnected network of at least two floating desalination units, wherein each float unit is comprised of at least one of said at least one wave tank and at least one of said at least one condensation tank, wherein each of said float units is connected to at least one other float unit by a resistance plate.

26. A method for desalination of salt water comprising:
isolating, using a wave tank, a volume of air above the surface of a body salt water;
directing salt water from the body of salt water toward the volume of air and placing said salt water in contact with said said isolated volume of air using a water supply, wherein the water supply is open at one end to the body of salt water and directs water toward the volume of air above the surface of the body of salt water, such that naturally occurring wave motion in the body of water is communicated through the partially enclosed volume of salt water;
using natural wave motion communicated through the partial enclosure to agitate salt water that is directed toward the volume of air above the surface of the body of salt water to increase water saturation in the volume of air;
transferring water saturated air from the wave tank to a condensation tank, wherein the transfer is accomplished using a first one-way conduit from the wave tank to the condensation tank, and wherein the transfer uses pressure fluctuations caused by the natural wave motion to force air through the first one-way conduit; and
condensing water within the condensation tank.

27. The method of claim 26, further comprising:
returning partially desaturated air from the condensation tank to the wave tank using a second one-way conduit from the condensation tank to the wave tank, wherein the transfer is effected using pressure fluctuations caused by the natural wave motions in the wave tank.

28. The method of claim 26, wherein the partially desatured air in the second one-way conduit is vented into the wave tank at a point adjacent to an opening of the salt water supply into the interior of the wave tank, said venting creating an aerosol of salt water.

29. The method of claim 26, further comprising creating a heat differential between the wave tank and the condensation tank.

30. The method of claim 29, wherein the heat differential is created using a first material as an external surface of the wave tank and a second material as an external surface of the condensation tank, said first material being substantially light absorbing to generate heat, and said second material being substantially light reflective.

31. The method of claim 29, wherein the heat differential is created using a first material as an external surface of the wave tank and a second material as an external surface of the condensation tank, said first material allowing visible light into the wave tank but substantially preventing infrared radiation from escaping in order to trap heat.

32. The method of claim 29, wherein the heat differential is created by positioning the wave tank and the condensation tank so that the outer surface of the wave tank receives more sun exposure than the outer surface of the condensation tank.

33. The method of claim 29, wherein a solar generator connected locally to the wave tank is used to introduce heat into the wave tank.

34. The method of claim 29, further comprising using a heat exchanger to induce the formation of condensation.

35. The method of claim 29, further comprising using heat conductive fins extending into the condensation tank to induce formation of condensation.

36. The method of claim 26, further attaching at least one turbine generator to the condensation tank, and using fluid forced out of the condensation chamber by wave-powered pressure increases to power the turbine.

37. The method of claim 26, further comprising:
allowing salt water to enter the condensation tank as ballast via a vent, said salt water being separated from fresh water within the condensation chamber by a flexible membrane that is not permeable to water, said membrane dividing the condensation chamber into an air bladder and water bladder; and
pumping air into the air bladder within the condensation tank to control the ballast level within the condensation tank.

38. The method of claim 26, wherein air pressure within the condensation tank is maintained at a level higher than atmospheric pressure, but lower than the maximum air pressure experienced in the wave tank during a wave cycle.
